(19) United States
(12) Patent Application Publication
(10) Pub. No.: US 2023/0417883 A1
(43) Pub. Date: Dec. 28, 2023

(54) RANGING DEVICE, RANGING METHOD AND COMPUTER READABLE MEDIUM

(71) Applicant: Mitsubishi Electric Corporation, Tokyo (JP)

(72) Inventor: Masashi FUKUNAGA, Tokyo (JP)

(73) Assignee: Mitsubishi Electric Corporation, Tokyo (JP)

(21) Appl. No.: 18/367,524

(22) Filed: Sep. 13, 2023

Related U.S. Application Data
(63) Continuation of application No. PCT/JP2021/017411, filed on May 6, 2021.

(51) Int. Cl. G01S 7/4861; G01S 7/486; G01S 7/495

(52) U.S. Cl. CPC G01S 7/4861; G01S 7/4868; G01S 7/495

(57) ABSTRACT

A sensitivity adjustment unit (102) adjusts a responsivity of a light receiving element (400) so that the responsivity becomes high. A noise removal unit (103) analyzes, after the responsivity is adjusted by the sensitivity adjustment unit (102), a temporal transition of a phase difference between an irradiation light emitted from a light emitting element (300) paired with the light receiving element (400) and a light received by the light receiving element (400) including a reflected light reflected by a ranging target (200) being a target of ranging, and removes a noise component included in the light received by the light receiving element (400).

### CROSS REFERENCE TO RELATED APPLICATIONS

This application is a Continuation of PCT International Application No. PCT/JP2021/017411 filed on May 6, 2021, which is hereby expressly incorporated by reference into the present application.

### TECHNICAL FIELD

The present disclosure relates to a technique to perform ranging using light.

### BACKGROUND ART

As a ranging technique, there exists a technique to measure a distance to a ranging target, using light.

There are two kinds of ranging using light, direct ranging and indirect ranging. The direct ranging is to carry out ranging using a ToF (Time of Flight) principle. Meanwhile, the indirect ranging is to carry out ranging using a phase difference of sensed light.

The ToF principle is a method to calculate a distance based on the time it takes for a light to travel back and forth between the ranging target and a sensor. Meanwhile, as one principle of indirect ranging, there exists an indirect ToF principle. In the indirect ToF principle, amplitude modulation is applied to the light used for ranging. Then, in the indirect ToF principle, a distance is indirectly calculated from a phase difference between an irradiation light applied to the ranging target, and a reflected light reflected by the ranging target. The present invention relates to a ranging technique using the indirect ToF principle.

Further, a wavelength of the light used in ranging varies depending on ranging targets. When a small object such as gas, a particle, etc. is the ranging target, light with a small wavelength, such as ultraviolet light, is used. Meanwhile, when an object having a certain size, such as a human, a vehicle, etc., is the ranging target, light with a large wavelength, such as infrared light, is used.

Especially, a ranging device to carry out ranging using near-infrared light is called a LiDAR (Light Detection and Ranging). The LiDAR is mounted on a mobility vehicle such as an automobile, a drone, etc., and is expected to be used in a wide range of places in the future.

A photodiode is generally used as a light receiving element of a sensor in a light ranging device. The light ranging device using a photodiode is assumed to be used under various environments such as indoor, outdoor, during daytime, and during nighttime.

Therefore, a method to remove noises in order to maintain sensitivity is adopted in the light ranging device using the photodiode. Specifically, in this light ranging device, noises are removed by maximizing an S/N ratio by adjusting the sensitivity of the light receiving element.

For example, Patent Literature 1 discloses a light ranging device using an APD (Avalanche Photo Diode) as a light receiving element. Further, Patent Literature 1 discloses a method to maximize an S/N ratio by controlling a bias voltage applied to the APD. The APD is a light receiving element capable of heightening the sensitivity of a photodiode, using an avalanche amplification principle. By controlling the voltage applied to the APD, it is possible to maintain the most sensitive state.

### CITATION LIST

### Patent Literature

Patent Literature 1: JP2008-286669 A

### SUMMARY OF INVENTION

### Technical Problem

Since a light ranging device uses light, a substance less likely to reflect light (blind spot) and an interference attack become a threat.

The interference attack is an attack that makes ranging difficult by interfering with reflected light. As an interference attack, there exists a blind attack that intendedly decreases a light quantity of the reflected light, and makes it difficult to perform ranging correctly. The countermeasure to the interference attack including the blind attack is difficult, and the interference attack is a fatal problem for the light ranging device having only one sensor.

For example, in a case wherein a light quantity of reflected light extremely decreases due to the blind attack, a countermeasure to heighten responsivity of the light receiving element of the ranging device is taken into account. However, when the responsivity of the light receiving element is heightened, the light received by the light receiving element shall include a large quantity of light other than the reflected light. As a result, noise components are increased in an electric signal output by the light receiving element. Therefore, there is a problem of failing to perform ranging correctly due to existence of noise components when the responsivity of the light receiving element is heightened in a case wherein the light quantity of the reflected light is decreased.

The present disclosure is mainly aimed at resolving this problem. More specifically, the present disclosure is mainly aimed at making correct ranging possible even when a light quantity of reflected light is decreased.

### Solution to Problem

A ranging device according the present disclosure, includes:
a sensitivity adjustment unit to adjust a responsivity of a light receiving element so that the responsivity becomes high; and
a noise removal unit to analyze, after the responsivity is adjusted by the sensitivity adjustment unit, a temporal transition of a phase difference between an irradiation light emitted from a light emitting element paired with the light receiving element and a light received by the light receiving element including a reflected light reflected by a ranging target being a target of ranging, and to remove a noise component included in the light received by the light receiving element.

### Advantageous Effects of Invention

According to the present disclosure, it is possible to perform correct ranging even when a light quantity of reflected light is decreased.

### BRIEF DESCRIPTION OF DRAWINGS

FIG. 1 is a diagram illustrating an example of a functional configuration of a ranging device according to a first embodiment;

FIG. 2 is a diagram illustrating an example of a hardware configuration of the ranging device according to the first embodiment; and

FIG. 3 is a flowchart illustrating an operation example of the ranging device according to the first embodiment.

### DESCRIPTION OF EMBODIMENTS

Hereinafter, description will be made on an embodiment with reference to diagrams. In the following description and diagrams of the embodiment, same elements or corresponding elements are denoted by same reference numerals.

### First Embodiment

### Description of Configuration

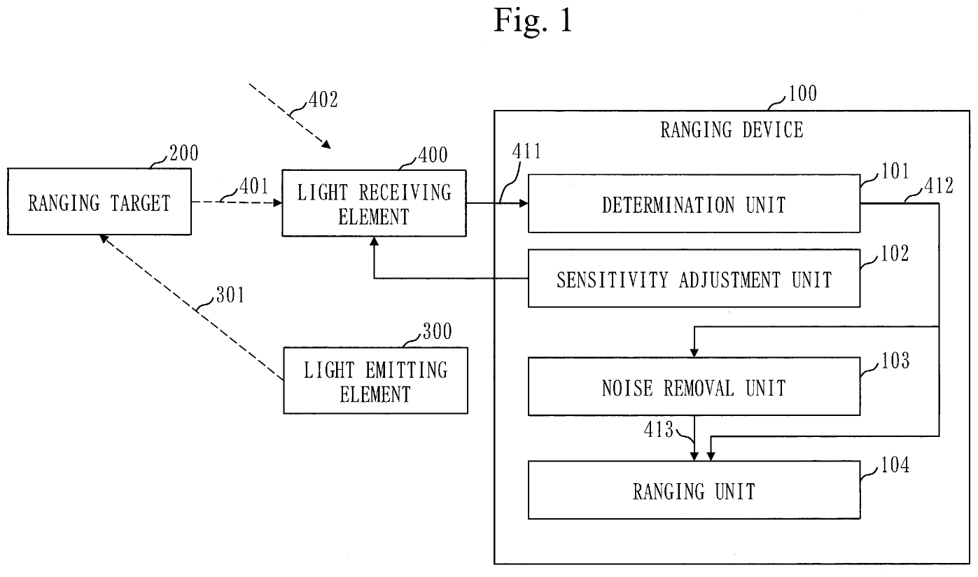

FIG. 1 illustrates an example of a functional configuration of a ranging device 100 according to a present embodiment.

In FIG. 1, each of a ranging device 100, a light emitting element 300 and a light receiving element 400 is illustrated as an independent and separate apparatus; however, the ranging device 100, the light emitting element 300 and the light receiving element 400 may be integrated.

The light emitting element 300 emits light toward a ranging target 200 being a target of ranging. Hereinafter, the light emitted by the light emitting element 300 is called irradiation light 301.

The light emitting element 300 emits, for example, a radar pulse, as the irradiation light 301.

The light receiving element 400 receives light, which is the irradiation light 301 reflected by the ranging target 200. Hereinafter, the light reflected by the ranging target 200 is called reflected light 401.

The light receiving element 400 receives also a disturbance light 402 besides the reflected light 401.

The light receiving element 400 performs photoelectric conversion of the light received, and transmits an electric signal acquired by the photoelectric conversion to the ranging device 100. Hereinafter, the electric signal transmitted to the ranging device 100 by the light receiving element 400 is called a light reception signal 411.

In the present embodiment, the light receiving element 400 is a DPD (Dynamic Photo Diode). The DPD is a photodiode which operates on low voltage, whereof the responsivity is adjustable. The DPD is operable on low voltage unlike the APD, and is capable of realizing measurement accuracy higher than the APD under weak light.

The light emitting element 300 and the light receiving element 400 constitute a LiDAR as a pair.

The ranging device 100 measures a distance from the light receiving element 400 to the ranging target 200.

The ranging device 100 is a computer. The operation procedure of the ranging device 100 corresponds to a ranging method. Further, a program to realize the operation of the ranging device 100 corresponds to a ranging program.

The ranging device 100 includes a determination unit 101, a sensitivity adjustment unit 102, a noise removal unit 103 and a ranging unit 104.

The determination unit 101 receives a light reception signal 411 from the light receiving element 400. Then, the determination unit 101 performs FFT (Fast Fourier Transform) on the light reception signal 411. Hereinafter, the light reception signal 411 whereon FFT has been performed is called an FFT signal 412.

Further, the determination unit 101 analyzes the FFT signal 412, and determines whether the light receiving intensity of the light receiving element 400 is appropriate. When the light receiving intensity of the light receiving element 400 is not appropriate, the determination unit 101 decides to change the responsivity of the light receiving element 400. In the present embodiment, as a responsivity mode of the light receiving element 400, there exists a high-sensitivity mode and a normal-sensitivity mode. When the light receiving intensity of the light receiving element 400 is determined to be too small, the determination unit 101 decides to change the responsivity mode of the light receiving element 400 to the high-sensitivity mode. Meanwhile, when the light receiving intensity of the light receiving element 400 is determined to be too large, the determination unit 101 decides to change the responsivity mode of the light receiving element 400 to the normal-sensitivity mode.

Furthermore, the light receiving intensity of the light receiving element 400 is appropriate, and the present responsivity mode is the high-sensitivity mode, the determination unit 101 outputs the FFT signal 412 to the noise removal unit 103. Meanwhile, when the light receiving intensity of the light receiving element 400 is appropriate, and the present responsivity mode is the normal-sensitivity mode, the determination unit 101 outputs the FFT signal 412 to the ranging unit 104.

The sensitivity adjustment unit 102 adjusts the responsivity of the light receiving element 400 in accordance with the decision by the determination unit 101.

When the determination unit 101 decides to change the responsivity mode of the light receiving element 400 to the high-sensitive mode, the sensitivity adjustment unit 102 changes the responsivity mode of the light receiving element 400 to the high-sensitive mode. That is, the sensitivity adjustment unit 102 adjusts the responsivity of the light receiving element 400 so that the responsivity of the light receiving element 400 becomes high. Meanwhile, when the determination unit 101 decides to change the responsivity mode of the light receiving element 400 to the normal-sensitivity mode, the sensitivity adjustment unit 102 changes the responsivity mode of the light receiving element 400 to the normal-sensitivity mode. That is, the sensitivity adjustment unit 102 adjusts the responsivity of the light receiving element 400 so that the responsivity of the light receiving element 400 becomes low.

Specifically, the sensitivity adjustment unit 102 controls a reverse bias voltage to adjust the responsivity of the light receiving element 400. When the responsivity of the light receiving element 400 is heightened, the sensitivity adjustment unit 102 applies the reverse bias voltage to the light receiving element 400. By applying the reverse bias voltage to the light receiving element 400 (DPD), it is possible to accelerate an electron generated at the time when a photon collides with an atom of a semiconductor. As a result, it becomes possible for the light receiving element 400 to capture weak light. Meanwhile, when the responsivity of the light receiving element 400 is lowered, the sensitivity adjustment unit 102 stops application of the reverse bias voltage.

The process performed by the sensitivity adjustment unit 102 corresponds to a sensitivity adjustment process.

The noise removal unit 103 removes a noise component from the FFT signal 412 output from the determination unit 101. That is, when the responsivity mode of the light receiving element 400 is the high-sensitivity mode, and the light receiving intensity of the light receiving element 400 is appropriate, the noise removal unit 103 removes the noise component from the FFT signal 412. When the responsivity of the light receiving element 400 is heightened, the light received by the light receiving element 400 shall include a large quantity of disturbance light 402, and the FFT signal 412 shall include a large quantity of noise components. Therefore, the noise removal unit 103 removes noise components from the FFT signal 412.

More specifically, the noise removal unit 103 analyzes the temporal transition of a phase difference between the irradiation light 301 and the light received by the light receiving element 400 (the reflected light 401 and the disturbance light 402) in the FFT signal 412. Then, the noise removal unit 103 removes, as the noise component, a component whereof a phase difference with the irradiation light 301 randomly changes from the components included in the light received by the light receiving element 400.

The noise removal unit 103 outputs the FFT signal 412 which has been removed the noise component as a noise removal FFT signal 413 to the ranging unit 104.

The process performed by the noise removal unit 103 corresponds to a noise removal process.

The ranging unit 104 measures a distance from the light receiving element 400 to the ranging target 200, using the FFT signal 412 output from the determination unit 101. That is, when the responsivity mode of the light receiving element 400 is the normal-sensitivity mode, and the light receiving intensity of the light receiving element 400 is appropriate, the ranging unit 104 measures the distance from the light receiving element 400 to the ranging target 200, using the FFT signal 412.

Further, the ranging unit 104 measures the distance from the light receiving element 400 to the ranging target 200, using the noise removal FFT signal 413 output from the noise removal unit 193. That is, when the responsivity mode of the light receiving element 400 is the high-sensitivity mode, and the light receiving intensity of the light receiving element 400 is appropriate, the ranging unit 104 measures the distance from the light receiving element 400 to the ranging target 200, using the noise removal FFT signal 413 being the FFT signal 412 in a state of being removed the noise component by the noise removal unit 103.

The ranging unit 104 may output the ranging result in an application program inside the ranging device 100, or in an application program outside the ranging device 100. Further, the ranging unit 104 may store the ranging result in an auxiliary storage device 903 to be described below without outputting the ranging result.

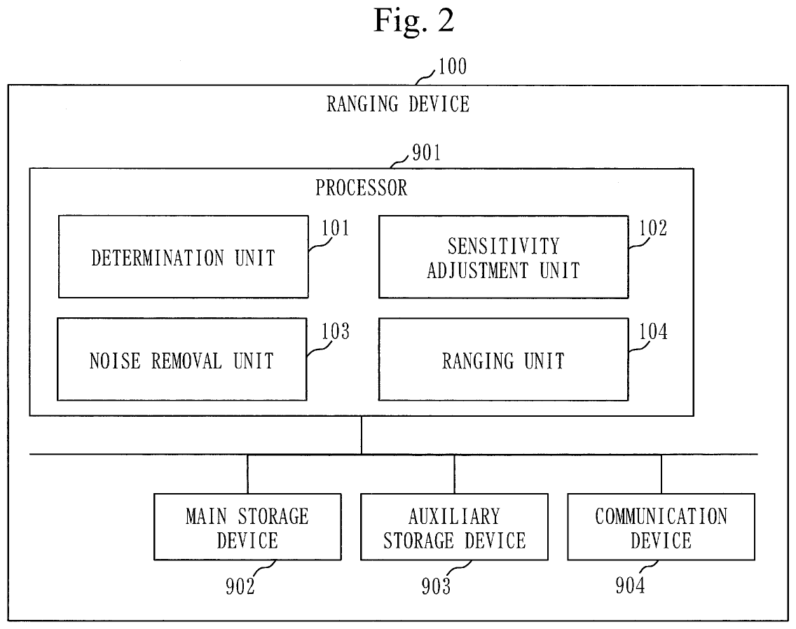

FIG. 2 illustrates an example of a hardware component of the ranging device 100 according to the present embodiment.

The ranging device 100 includes a processor 901, a main storage device 902, the auxiliary storage device 903 and a communication device 904 as hardware components.

The auxiliary storage device 903 stores programs to realize functions of the determination unit 101, the sensitivity adjustment unit 102, the noise removal unit 103 and the ranging unit 104.

These programs are loaded into the main storage device 902 from the auxiliary storage device 903. Then, the processor 901 executes these programs, and performs operations of the determination unit 101, the sensitivity adjustment unit 102, the noise removal unit 103 and the ranging unit 104.

FIG. 2 schematically illustrates a state wherein the processor 901 executes the programs to realize the functions of the determination unit 101, the sensitivity adjustment unit 102, the noise removal unit 103 and the ranging unit 104.

### Description of Operation

Next, description will be made on an operation example of the ranging device 100 according to the present embodiment.

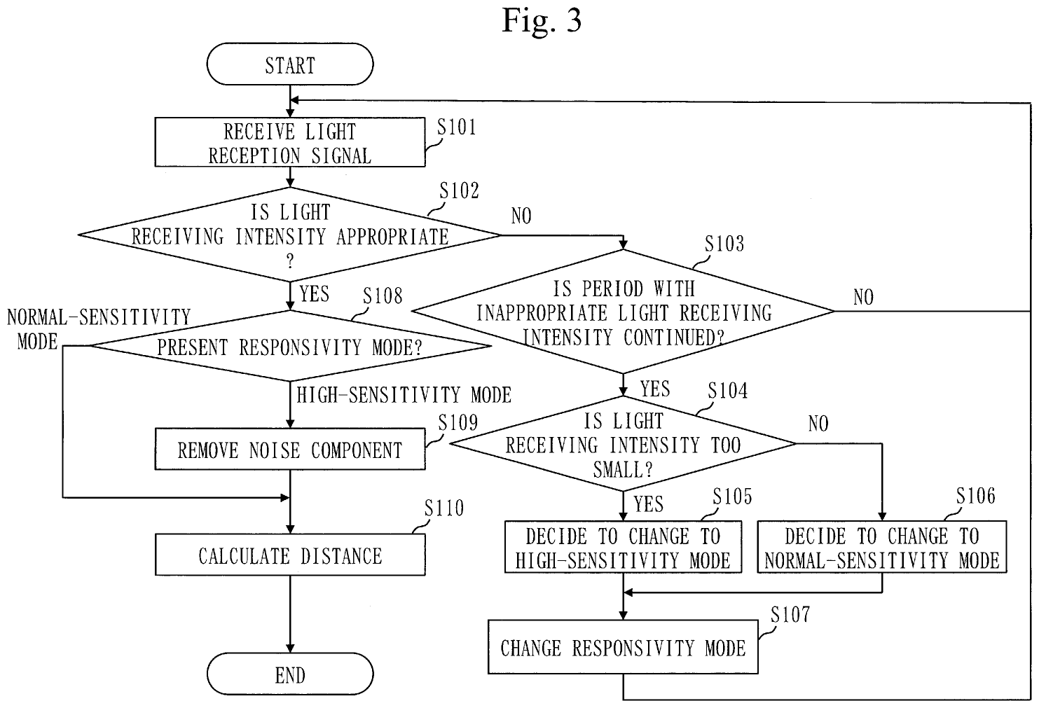

FIG. 3 is a flowchart illustrating an operation example of the ranging device 100 according to the present embodiment. Hereinafter, description will be made on the operation example of the ranging device 100 according to the present embodiment with reference to FIG. 3,

In Step S101, the determination unit 101 receives the light reception signal 411 from the light receiving element 400 via the communication device 904. The light reception signal 411 is an electric signal obtained by photoelectric conversion in the light receiving element 400 as described above. The light reception signal 411 is a three-dimensional point cloud signal. The determination unit 101 performs FFT on the light reception signal 411 received, and converts the light reception signal 411 into an FFT signal 412. The determination unit 101 performs, specifically, sampling of the light reception signal 411 at four points. By performing sampling of the light reception signal 411 at four points, it is possible for the determination unit 101 to obtain a phase difference between an irradiation light 301 and the reflected light 401 or a phase difference between the irradiation light 301 and the disturbance light 402 at each point of the three-dimensional point cloud. Further, by performing sampling of the light reception signal 411 at four points, it is possible for the determination unit 101 to obtain an intensity of the reflected light 401 or an intensity of the disturbance light 402 at each point of the three-dimensional point cloud.

Next, in Step S102, the determination unit 101 analyzes the FFT signal 412, and determines whether the light receiving intensity of the light receiving element 400 is appropriate. That is, the determination unit 101 determines whether the intensity of the light received by the light receiving element 400 is appropriate. As described above, the light received by the light receiving element 400 includes the disturbance light 402 besides the reflected light 401.

Specifically, in a case wherein the light receiving intensity is too small, or the light receiving intensity is too large, the determination unit 101 determines that the light receiving intensity is not appropriate. The case wherein the light receiving intensity is too small is a case wherein a value of the light receiving intensity at each point of the three-dimensional point cloud is 0 (invalid value). Meanwhile, the case wherein the light receiving intensity is too large is a case wherein a value of the receiving light intensity at each point of the three-dimensional point cloud is saturated at the largest value (invalid value). The determination unit 101 decides that the light receiving intensity is appropriate in cases other than the case wherein the light receiving intensity is too small or too large.

When the light receiving intensity is inappropriate, the process proceeds to Step S103.

When the light receiving intensity is appropriate, the process proceeds to Step S108.

In Step S103, the determination unit 101 determines whether a period wherein the light receiving intensity is inappropriate is still continued

For example, when it is determined that the light receiving intensity is inappropriate for two consecutive times, the determination unit 101 determines that a period wherein the light receiving intensity is inappropriate is still continued.

When the determination unit 101 determines that the period wherein the light receiving intensity is inappropriate is still continued, the process proceeds to Step S104.

Meanwhile, when the determination unit 101 does not determine that the period wherein the light receiving intensity is inappropriate is still continued, the process proceeds to Step S101, waits for reception of a next light reception signal 411 from the light receiving element 400, and performs the process as described above on the light reception signal 411 received next.

In Step S104, the determination unit 101 determines whether the light receiving intensity is too small.

When the light receiving intensity is too small, the process proceeds to Step S105. Meanwhile, when the light receiving intensity is too large, the process proceeds to Step S106.

In Step S105, the determination unit 101 decides to change the responsivity mode of the light receiving element 400 to the high-sensitivity mode. That is, since the light receiving intensity of the light receiving element 400 is too small in the normal-sensitivity mode, the determination unit 101 determines that it is necessary to heighten responsivity of the light receiving element 400.

The determination unit 101 outputs a high-sensitivity mode direction signal to direct the sensitivity adjustment unit 102 to change the responsivity mode to the high-sensitivity mode.

Further, the determination unit 101 sets a sensitivity mode flag indicating a present responsivity mode of the light receiving element 400 to a high-sensitive mode.

In Step S106, the determination unit 101 decides to change the responsivity mode of the light receiving element 400 to the normal-sensitivity mode. That is, since the light receiving intensity of the light receiving element 400 is too large in the high-sensitivity mode, the determination unit 101 determines that it is necessary to lower the responsivity of the light receiving element 400.

The determination unit 101 outputs a normal-sensitivity mode direction signal to direct the sensitivity adjustment unit 102 to change the responsivity mode to the normal-sensitivity mode.

Further, the determination unit 101 sets a sensitivity mode flag to the normal-sensitivity mode.

Next, in Step S107, the sensitivity adjustment unit 102 changes the responsivity mode of the light receiving element 400 in accordance with a direction signal from the determination unit 101.

That is, when the high-sensitivity mode direction signal is output from the determination unit 101, the sensitivity adjustment unit 102 changes the responsivity mode of the light receiving element 400 to the high-sensitivity mode. Specifically, the sensitivity adjustment unit 102 applies a reverse bias voltage to the light receiving element 400, and heightens the responsivity of the light receiving element 400.

Meanwhile, when the normal-sensitivity mode direction signal is output from the determination unit 101, the sensitivity adjustment unit 102 changes the responsivity mode of the light receiving element 400 to the normal-sensitivity mode. Specifically, the sensitivity adjustment unit 102 stops application of the reverse bias voltage to the light receiving element 400, and lowers the responsivity of the light receiving element 400.

Then, the process returns to Step S101.

Further, when the light receiving intensity of the light receiving element 400 is determine to be appropriate in Step S102, the determination unit 101 checks the present responsivity mode in Step S108.

Specifically, the determination unit 101 refers to the sensitivity mode flag, and checks the present responsivity mode.

When the present responsivity mode is the high-sensitivity mode, the process proceeds to Step S109. Further, in this case, the determination unit 101 outputs an FFT signal 412 to the noise removal unit 103.

Meanwhile, when the present responsivity mode is the normal-sensitivity mode, the process proceeds to Step S110. Further, in this case, the determination unit 101 outputs the FFT signal 412 to the ranging unit 104.

In Step S109, the noise removal unit 103 analyzes a temporal transition of a phase difference at each point included in the FFT signal 412, extracts a noise component, and removes the noise component extracted, from the FFT signal 412.

The noise removal unit 103 generates time-series information of a phase difference at each point from FFT signals 412 of n (n≥2) times. For example, by assuming that n=2, it is considered that the noise removal unit 103 generates the time-series information of the phase difference at each point from the latest FFT signal 412 and the previous FFT signal 412. Then, the noise removal unit 103 analyzes the time-series information of the phase difference at each point, and extracts the noise component.

The phase difference at a point corresponding to a signal component (point inside the ranging target 200) is a phase difference between the irradiation light 301 and the reflected light 401. Therefore, the phase difference at the point corresponding to the signal component changes in accordance with the distance between the ranging target 200 and the light receiving element 400. For example, in a case wherein at least any of the ranging target 200 and the light receiving element 400 is moving, the phase difference at the point corresponding to the signal component changes in proportion to movement of at least any of the ranging target 200 and the light receiving element 400. Further, in a case wherein the ranging target 200 and the ranging target 200 remain stationary, the phase difference at the point corresponding to the signal component does not change. As described, at the point corresponding to the signal component, regularity can be found in the temporal transition of the phase difference. Meanwhile, the phase difference at a point corresponding to a noise component (point outside the ranging target 200) is a phase difference between the irradiation light 301 and the disturbance light 402. Therefore, the phase difference at the point corresponding to the noise component randomly changes, and regularity cannot be found.

The noise removal unit 103 extracts this point where the phase difference randomly changes as a noise component, and removes the noise component extracted, from the FFT signal 412.

Then, the noise removal unit 103 outputs the FFT signal 412 that has been removed the noise component as a noise removal FFT signal 413 to the ranging unit 104.

Next, the process proceeds to Step S110.

In Step S110, the ranging unit 104 measures the distance between the ranging target 200 and the light receiving element 400.

When the FFT signal 412 is output from the determination unit 101, the ranging unit 104 measures the distance from the light receiving element 400 to the ranging target 200, using the FFT signal 412. Meanwhile, when the noise removal FFT signal 413 is output from the noise removal unit 103, the ranging unit 104 measures the distance from the light receiving element 400 to the ranging target 200, using the noise removal FFT signal 413.

The ranging unit 104 measures the distance from the light receiving element 400 to the ranging target 200 based on an indirect ToF principle in any cases using any of the FFT signal 412 and the noise removal FFT signal 413.

Next, description will be made specifically on a flow illustrated in FIG. 3.

When a blind attack occurs, or the ranging target 200 moving enters a blind spot, the light quantity of the reflected light 401 is extremely decreased. That is, a state wherein the light receiving intensity is 0 continues.

Therefore, the period wherein the light receiving intensity of the light receiving element 400 is determined to be inappropriate by the determination unit 101 is continued (NO in Step S102, and YES in Step S103). As a result, the determination unit 101 decides to change the responsivity mode of the light receiving element 400 to the high-sensitive mode (YES in Step S104, and Step S105), and the sensitivity adjustment unit 102 heightens the responsivity of the light receiving element 400 (Step S107).

Then, since the determination unit 101 determines that the responsivity of the light receiving element 400 is appropriate (YES in Step S102), and the present responsivity mode is the high-sensitivity mode (“high-sensitivity mode” in Step S108), the noise removal unit 103 removes the noise component from the FFT signal 412. When the responsivity of the light receiving element 400 is heightened, the light received by the light receiving element 400 shall include a large quantity of disturbance lights 402, and the FFT signal 412 shall include a large quantity of noise components. Therefore, the noise removal unit 103 removes the noise components from the FFT signal 412. As a result, the ranging unit 104 measures the distance to the ranging target 200, using the noise removal FFT signal 413.

Meanwhile, when the blind attack is finished, or the ranging target 200 moves out of the blind spot, the light quantity of the reflected light 401 is extremely increased. That is, the state wherein the value of light receiving intensity is the largest value continues.

Therefore, the period wherein the light receiving intensity of the light receiving element 400 is determined to be inappropriate by the determination unit 101 is continued (NO in Step S102 and YES in Step S103). As a result, the determination unit 101 decides to change the responsivity mode of the light receiving element 400 into the normal-sensitivity mode (NO in Step S104, and Step S106), and the sensitivity adjustment unit 102 lowers the responsivity of the light receiving element 400 (Step S107).

Then, since the determination unit 101 determines that the light receiving intensity of the light receiving element 400 is appropriate (YES in Step S102), and the present responsivity mode is the normal-sensitivity mode (“normal-sensitivity mode” in Step S108), there is no necessity for the noise removal unit 103 to remove a noise component from the FFT signal 412. That is, the light received by the light receiving element 400 does not include a large quantity of disturbance lights 402, and the FFT signal 412 does not include a large quantity of noise components. Therefore, it is unnecessary to remove the noise components. The ranging unit 104 measures the distance to the ranging target 200, using the FFT signal 412 without change.

### Description of Effect of Embodiment

In the present embodiment, responsivity is adjusted in response to a light quantity of reflected light, and a noise component which is increased due to adjustment of the responsivity is removed. Therefore, according to the present embodiment, even when the light quantity of the reflected light is decreased due to a blind attack or a blind spot, it is possible to heighten an S/N ratio, and perform ranging correctly.

It may be possible to perform only a part of the procedures described in the present embodiment.

Further, it may be possible to combine and perform at least a part of the procedures described in the present embodiment and a procedure that is not described in the present embodiment.

Additionally, it may be possible to change the configuration and the procedures described in the present embodiment as needed.

### Supplementary Description of Hardware Configuration

Last, supplementary description of a hardware configuration of the ranging device 100 will be made.

The processor 901 as illustrated in FIG. 2 is an IC (Integrated Circuit) to perform processing.

The processor 901 is a CPU (Central Processing Unit), a DSP (Digital Signal Processor), or the like.

The main storage device 902 as illustrated in FIG. 2 is a RAM (Random Access Memory).

The auxiliary storage device 903 as illustrated in FIG. 2 is a ROM (Read Only Memory), flash memory, an HDD (Hard Disk Drive), or the like.

The communication device 904 as illustrated in FIG. 2 is an electronic circuit to perform data communication processing.

The communication device 904 is, for example, a communication chip or an NIC (Network Interface Card).

Further, the auxiliary storage device 903 also stores an OS (Operating System).

In addition, at least a part of the OS is executed by the processor 901.

The processor 901 executes the programs to realize the functions of the determination unit 101, the sensitivity adjustment unit 102, the noise removal unit 103 and the ranging unit 104 while executing at least a part of the OS.

By executing the OS by the processor 901, task management, memory management, file management and communication control, and the like are performed.

Further, at least any of information, data, signal values and variable values indicating the results of processes by the determination unit 101, the sensitivity adjustment unit 102, the noise removal unit 103 and the ranging unit 104 is stored in at least any of the main storage device 902, the auxiliary storage device 903, a register and a cache memory inside the processor 901.

Furthermore, the programs to realize the functions of the determination unit 101, the sensitivity adjustment unit 102, the noise removal unit 103 and the ranging unit 104 may be stored in a portable recording medium such as a magnetic disk, a flexible disk, an optical disk, a compact disk, a Blue-ray (registered trademark) disk, a DVD (digital versatile disk), etc. Additionally, it may be possible to distribute a portable recording medium wherein the programs to realize the functions of the determination unit 101, the sensitivity adjustment unit 102, the noise removal unit 103 and the ranging unit 104 are stored.

Further, “unit” of the determination unit 101, the sensitivity adjustment unit 102, the noise removal unit 103 and the ranging unit 104 may be replaced with “circuit”, “step”, “procedure”, “process” or “circuitry”.

In addition, the ranging device 100 may be realized by a processing circuit. The processing circuit is, for example, a logic IC (Integrated Circuit), a GA (Gate Array), an ASIC (Application Specific Integrated Circuit) or an FPGA (Field-Programmable Gate Array).

In this case, the determination unit 101, the sensitivity adjustment unit 102, the noise removal unit 103 and the ranging unit 104 are each realized as a part of the processing circuit.

In the present specification, a superordinate concept of the processor and the processing circuit is called “processing circuitry”.

That is, each of the processor and the processing circuit is a concrete example of “processing circuitry”.

### REFERENCE SIGNS LIST

100: ranging device; 101: determination unit; 102: sensitivity adjustment unit; 103: noise removal unit; 104: ranging unit; 200: ranging target; 300: light emitting element; 301: irradiation light; 400: light receiving element; 401: reflected light; 402: disturbance light; 411: light reception signal; 412: FFT signal; 413: noise removal FFT signal; 901: processor; 902: main storage device; 903: auxiliary storage device; 904: communication device.

1. A ranging device comprising:
processing circuitry:
to adjust a responsivity of a light receiving element so that the responsivity becomes high; and
to analyze, after the responsivity is adjusted, a temporal transition of a phase difference between an irradiation light emitted from a light emitting element paired with the light receiving element and a light received by the light receiving element including a reflected light reflected by a ranging target being a target of ranging, and to remove a noise component included in the light received by the light receiving element.

2. The ranging device as defined in claim 1, wherein the processing circuitry removes, as the noise component, a component whereof the phase difference with the irradiation light randomly changes, among components included in the light received by the light receiving element.

3. The ranging device as defined in claim 1, wherein
the processing circuitry
determines whether a light receiving intensity of the light receiving element after the responsivity is adjusted is appropriate, and
analyzes the temporal transition of the phase difference and removes the noise component, when the light receiving intensity is determined to be appropriate.

4. The ranging device as defined in claim 1, wherein
the processing circuitry
determines whether a light receiving intensity of the light receiving element is appropriate, to decide to heighten the light receiving intensity of the light receiving element when the light receiving intensity is too small, and to decide to lower the light receiving intensity of the light receiving element when the light receiving intensity is too large, and
adjusts the responsivity of the light receiving element so that the responsivity becomes high when it is decided to heighten the responsivity, and adjusts the responsivity of the light receiving element so that the responsivity becomes low when it is decided to lower the responsivity.

5. The ranging device as defined in claim 4, wherein the processing circuitry does not analyze the phase difference and does not remove the noise component, when the responsivity is adjusted to become low.

6. The ranging device as defined in claim 1, wherein the light receiving element is a DPD (dynamic photo diode).

7. A ranging method comprising:
adjusting a responsivity of a light receiving element so that the responsivity becomes high; and
analyzing, after the responsivity is adjusted, a temporal transition of a phase difference between an irradiation light emitted from a light emitting element paired with the light receiving element and a light received by the light receiving element including a reflected light reflected by a ranging target being a target of ranging, and removing a noise component included in the light received by the light receiving element.

8. A non-transitory computer readable medium storing a ranging program to make a computer perform:
a sensitivity adjustment process to adjust a responsivity of a light receiving element so that the responsivity becomes high; and
a noise removal process to analyze, after the responsivity is adjusted by the sensitivity adjustment process, a temporal transition of a phase difference between an irradiation light emitted from a light emitting element paired with the light receiving element and a light received by the light receiving element including a reflected light reflected by a ranging target being a target of ranging, and to remove a noise component included in the light received by the light receiving element.
